(19) United States
(12) Patent Application Publication
(10) Pub. No.: US 2004/0019651 A1
(43) Pub. Date: Jan. 29, 2004

(54) Categorizing electronic messages based on collaborative feedback

(76) Inventor: Kristian L. M. Andaker, Bellevue, WA (US)

Correspondence Address: RICK D. NYDEGGER, WORKMAN, NYDEGGER & SEELEY, 1000 Eagle Gate Tower, 60 East South Temple, Salt Lake City, UT, 84111, US

(21) Appl. No.: 10/208,150

(22) Filed: Jul. 29, 2002

(51) Int. Cl. G06F 15/16

(52) U.S. Cl. 709/207

(57) ABSTRACT

Electronic messages are categorized based on collaborative feedback from a number of electronic message recipients. An electronic message that has particular characteristics is received. Electronic message recipients can provide express feedback to a collaborative filter module indicating that the received electronic message is an unwanted electronic message. When the level of express feedback exceeds a specified threshold, the collaborative filter module may automatically categorize the electronic message as unwanted for other recipients that have not yet accessed the electronic message. The collaborative filter module can also categorize the received electronic message as unwanted by analyzing the characteristics of the received electronic message. If the received electronic message has particular characteristics that a number of recipients have previously indicated are more likely in unwanted messages, the collaborative filter module may automatically categorize the electronic message as an unwanted electronic message.

### BACKGROUND OF THE INVENTION

1. The Field of the Invention

The present invention relates to electronic message filtering. More specifically, the present invention relates to systems, methods, and computer program product claims for categorizing an electronic message as an unwanted electronic message based on collaborative feedback.

2. Background and Relevant Art

Computer systems and related technology affect many aspects of society. Indeed, the computer system's ability to process information has transformed the way we live and work. Computer systems now commonly perform a host of tasks (e.g., database management, scheduling, and word processing) that prior to the advent of the computer system were performed manually. Additionally, network connectable computer systems often include the functionality to send and receive electronics messages, such as, for example, electronic mail messages. A user of a computer system with electronic mail functionality can send electronic mail messages to and receive electronic messages from other users that have computer systems with similar functionality.

To send an electronic mail message, a sending user typically manipulates an input device, such as a keyboard, within an active electronic mail application to enter text into a electronic mail message. The sending user also typically includes an electronic mail address of a recipient user in the electronic message, for example, by entering text in the “To” field. The sending user then sends the electronic mail message to the recipient user by selecting a “Send” control within the active electronic mail application. Sending the electronic message may cause the electronic mail message to be routed from the sending user's computer system, through a sending mail server, across a network, to a receiving mail server associated with the recipient user where the electronic mail message is stored.

To view the electronic mail message, the recipient user would use an active electronic mail application to establish a connection to the receiving mail server. Establishing the connection would typically cause all electronic mail messages sent to the recipient user, including the mail message from the sending user, to be transferred from the receiving mail server to the recipient user's computer system. After the electronic mail message from the sending user is transferred, the recipient user may manipulate an input device, such as, for example, a mouse to view the electronic mail message. Manipulating an input device often includes selecting an identifier (e.g. an icon), which represents the electronic mail message, from an “inbox” folder. When the identifier is selected the full text of the electronic message may become viewable to the recipient user.

Sending an electronic mail message to a recipient user is a relatively easy task, as all that is needed to route the electronic mail message is an electronic mail address of the recipient user. Further, most electronic mail applications allow a sending user to easily send the same electronic mail message to a number of recipient users by including multiple electronic mail address in the “To” field. Some electronic mail applications even include the functionality to configure a computer system to automatically send an electronic message to multiple recipient users without human intervention. Such computer systems are often configured to “mass mail” advertisements or marketing materials to large numbers of electronic mail addresses. These computer systems are also often configured to send mass mailings to a recipient user even if the recipient user has made no request to receive the mass mailing.

Thus, at times, recipient users may receive unsolicited electronic mail messages containing advertisements and marketing material. Most recipient users view these types of electronic mail messages as electronic junk mail, and these types of electronic mail messages are often referred to as “SPAM.” Receiving SPAM wastes the time of electronic mail recipients since time must be taken to review an electronic mail message before an electronic mail message can be identified as SPAM. Once identified as SPAM, additional time must be taken to delete the electronic mail message. As such, computerized techniques have been developed to detect SPAM and, after detection, process SPAM differently than other electronic mail messages.

One detection technique is to include an electronic mail filter in the recipient user's computer system. The recipient user configures the electronic mail filter by entering hard coded rules into a user interface associated with the electronic mail filter. The hard coded rules cause the electronic mail filter to categorize electronic mail messages based on their characteristics. A recipient user may configure an electronic mail filter so that electronic messages having certain characteristics are categorized as SPAM. An electronic mail filter can be further configured to process SPAM in a way that differs from other electronic mail messages.

For example, a recipient user may enter hard coded rules to configure an electronic mail filter so that electronic mail messages including specific text are categorized as SPAM and are automatically deleted. Each time an electronic mail message is sent to a recipient user, the electronic mail filter scans the electronic message for the specific text before the recipient user receives the electronic mail message. If the specified text is identified, the electronic mail filter categorizes the electronic mail message as SPAM. Once categorized as SPAM, the electronic mail message can be automatically deleted or moved to a SPAM folder without any intervention by the recipient user.

Electronic mail filters, if properly configured, can be useful for reducing the amount of SPAM received by a recipient user. However, electronic mail filters using hard coded rules require configuration by a recipient user before they are useful. Without configuration by a recipient user, such electronic mail filters have little, if any, chance of detecting SPAM. Additionally, if a recipient user changes what they consider SPAM, an electronic mail filter may need to be reconfigured by entering updated hard coded rules into the electronic mail filter. As such, more sophisticated individually “trainable” filters have been developed to categorize electronic messages.

An individually trainable filter is typically included in a recipient user's computer system. When an electronic message is received at the recipient user's computer system, the recipient user provides feedback about the received electronic message to the individually trainable filter. The individually trainable filter analyzes the feedback to incrementally generate rules that are used to categorize subsequently received electronic messages. After a sufficient amount of feedback is analyzed and corresponding rules generated, this eventually results in the individually trainable filter being able to automatically categorize electronic mail messages with little intervention from the recipient user.

One such individually trainable filter has been implemented to detect important electronic mail messages and distinguish these electronic mail messages from other unimportant electronic mail messages. Sometime after a recipient user receives an electronic mail message, the recipient user may provide feedback indicating that the electronic mail message is an important electronic mail message. The individually trainable filter receives this indication as input and analyzes the characteristics of the important electronic mail message (e.g. From and Cc fields, date it was sent, contents, etc.) The individually trainable filter then stores the characteristics of the important electronic mail message.

When a subsequent electronic mail message is received, the individually trainable filter analyzes the subsequent electronic mail message prior to the recipient user receiving the electronic mail message. If the subsequent electronic mail message has characteristics that match the stored characteristics with some level of specificity, the individually trainable filter may automatically categorize the subsequent electronic mail message as an important electronic mail message. Whether or not the individually trainable filter categorizes the subsequent electronic mail message as an important electronic mail message, the recipient user may still provide feedback on the subsequent electronic mail message. If the recipient user indicates that the subsequent electronic mail message is an important electronic mail message, the characteristics of the subsequent electronic mail message are stored along with the characteristics of other importance electronic messages.

Analyzing and storing characteristics of electronic mail messages can be a recurring process over the course of receiving a number of electronic mail messages. During the recurring process a recipient user may eventually train the individually trainable filter to automatically categorize important electronic mail messages with some degree of accuracy. This is beneficial as the recipient user can now categorize electronic mail messages and was not required to enter hard coded rules to configure an electronic mail filter. Another and more substantial benefit results when a recipient user changes the types of electronic mail messages that are important. Instead of having to reconfigure an electronic mail filter by entering updated hard coded rules, the individually trainable filter will simply adapt to the changes of the recipient user and begin to incrementally generate new rules.

Unfortunately, individually trainable filters suffer from at least one major drawback. A recipient user may need to provide feedback on hundreds of electronic messages before an individually trainable filter generates enough rules to automatically categorize electronic messages with any degree of accuracy. If a recipient user receives only two or three electronic mail messages a day, it may take weeks or months to generate a required threshold number of rules.

Therefore, what are desired are systems, methods, and computer program products, for more efficiently training filters that categorize electronic messages based on user feedback.

### BRIEF SUMMARY OF THE INVENTION

Methods, systems, and computer program products are described for categorizing electronic messages, such as, for example, electronic mail messages, instant messages, and news group postings based on feedback from a number of electronic message recipients (hereinafter referred to as “recipients”). More particularly, a collaborative filter module automatically categorizes electronic messages as “unwanted” based on feedback from a number of recipients that access electronic messages from an electronic messaging server (hereinafter referred to as a “server”). Unwanted electronic messages may be, for example, unsolicited or junk electronic mail messages (frequently referred to as “SPAM”) or electronic messages that include a malicious program, such as, for example, a virus or Trojan horse.

In some cases, a collaborative filter may categorize an electronic message as unwanted based on feedback specifically designating the electronic message as unwanted. A server may receive an electronic message that has a number of designated recipients. For example, a mail server may receive a electronic message that includes a number of electronic mail addresses in the “To” field of the electronic message. Each address in the “To” field may correspond to a designated message recipient. Accordingly, the mail server may transport a copy of the electronic message to a corresponding folder (e.g. an “Inbox”) associated with each designated recipient.

It is determined that the electronic message is an unwanted electronic message for at least one of the designated recipients based on feedback from some of the designated recipients. A designated recipient may provide feedback, for example, by selecting a “Spam indicator” control in a user interface or by deleting the electronic message “as Spam” (as opposed to just deleting it). When a specified number of designated recipients indicate that the electronic message is unwanted, a collaborative filter may determine that the electronic message is an unwanted electronic message for other designated recipients as well (including recipients that have not yet provided feedback).

It is automatically indicated that the electronic message is an unwanted electronic message to at least one designated recipient that has not provided feedback on whether the electronic message is unwanted. Indicating that an electronic message is unwanted may include presenting unwanted electronic messages differently from other electronic messages at a user interface. For example, unwanted electronic messages may automatically be put in a “SPAM” folder instead of an “Inbox” and/or may not cause a “New Mail” indication to be presented to a recipient.

In other cases, an electronic message may be categorized as unwanted based on the particular characteristics of the electronic message. A collaborative filter receives feedback from at least some of the recipients that access electronic messages from a server. The received feedback indicates that electronic messages having particular characteristics may be unwanted electronic messages. Characteristics of an electronic message may include, for example, the addresses in a “To,” “Cc,” or “From” field of the electronic message, key words in the body of the electronic message, the time and date the electronic message was sent, and files that are attached to the electronic message. The collaborative filter may combine feedback from each recipient with the feedback from all the other recipients to formulate the particular characteristics that are more common in unwanted electronic messages.

An electronic message that has the particular characteristics is received. It is automatically indicated that the electronic message is unwanted based on the received feedback. The characteristics of the received electronic message may be compared to the particular characteristics that are more common in unwanted electronic messages. For example, a collaborative filter may compare the “From” address of a received electronic message to determine if similarities exist to any “From” address that was indicated by recipient feedback to be more common in unwanted electronic messages. When an electronic message has characteristics similar to the particular characteristics that are more common in unwanted messages, the collaborative filter may automatically indicate that the electronic message is unwanted.

By using collaborative feedback, some users may be relieved from having to actually view an electronic message to determine that the electronic message is an unwanted electronic message Further, filters that categorize electronic messages based on the characteristics of electronic messages may be trained more efficiently since feedback is received from a number of users.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a computer system that provides a suitable operating environment for the present invention.

FIG. 2 illustrates an example of some of the functional components that can facilitate categorizing an electronic message as unwanted based on collaborative feedback.

FIG. 3 is a flow diagram illustrating an example of a method for categorizing an electronic message as unwanted based on some recipients of the electronic message indicating that the electronic message is unwanted.

FIG. 4 is a flow diagram illustrating an example of a method for categorizing an electronic message as unwanted based on the characteristics of the electronic message.

### DETAILED DESCRIPTION OF THE PREFERRED EMBODIMENTS

The present invention extends to systems, methods, and computer program products for categorizing electronic messages based on collaborative feedback. An electronic messaging server may receive an electronic message that has a plurality of designated recipients. A collaborative filter module contained in the electronic messaging server may categorize the electronic message based on feedback from a plurality of recipients. In some embodiments, the collaborative filter module categorizes the electronic message as an unwanted electronic message for at least one designated recipient based on feedback from some of the designated recipients. In these embodiments, feedback can include an express indication by some of the designated recipients that the received electronic message is an unwanted electronic message.

In other embodiments, the collaborative filter module categorizes the electronic message as an unwanted electronic message based on previously received feedback from a plurality of recipients. When an electronic message is received, the collaborative filter module can process previously received feedback to identify characteristics of electronic messages that are more common in unwanted electronic messages. The collaborative filter module can analyze a received electronic message to determine if the received electronic message has any of the characteristics that are more common in unwanted electronic messages. When an electronic message has characteristics that are more common in unwanted electronic messages the collaborative filter may initial categorize the electronic message as an unwanted electronic message.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system.

By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “network” is defined as any architecture where two or more computer systems may exchange data with each other. When information is transferred or provided over a network or another communications connection (either hardwired, wireless, or a combination of hardwired or wireless) to a computer system or computer device, the connection is properly viewed as a computer-readable readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions.

In this description and in the following claims, a “computer system” is defined as one or more software modules, one or more hardware modules, or combinations thereof, that work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

In this description and in the following claims, a “logical communication link” is defined as any communication path that may enable the transport of electronic data between two entities such as computer systems or modules. The actual physical representation of a communication path between two entities is not important and may change over time. A logical communication link may include portions of a system bus, a local area network, a wide area network, the Internet, combinations thereof, or portions of any other path that may facilitate the transport of electronic data. Logical communication links may include hardwired links, wireless links, or a combination of hardwired links and wireless links. Logical communication links may also include software or hardware modules that condition or format portions of data so as to make them accessible to components that implement the principles of the present invention. Such components may include, for example, proxies, routers, firewalls, or gateways. Logical communication links may also include portions of a Virtual Private Network (“VPN”).

In this description and in the following claims, an “electronic message” is defined as a grouping of electronic data that includes an identifier representing one more intended human electronic message recipients and a body containing text and/or graphics. Electronic message is defined to include an electronic mail message, an instant message, and a news group posting. An identifier can include, but is not limited to, an electronic mail address or alias, an instant messaging address or alias, or a name of a news group. Text included in the body of an electronic message can include characters from any number of character sets including, but not limited to, American Standard Code for Information Exchange (“ASCII”), American National Standards Institute (“ANSI”), character sets based on Japanese Industrial Standards (e.g. JIS X 0208-1990), and Unicode. Graphics included in the body of an electronic message can be based on any number of formats including, but not limited to, tagged image file format (“TIFF”), standard bit-mapped graphics format (“BMP”), PCX, graphics interchange format (“GIF”), and Joint Photographic Experts Group (“JPG”).

An electronic message recipient (hereinafter referred to simply as a “recipient”) can manipulate the controls of an electronic messaging application program (e.g. an electronic mail client program) to cause text and graphics contained in the body of an electronic message to be displayed at a video display device, such as, for example, at computer monitor 157. It should be understood that text or graphics contained in the body of an electronic message might be used to represent a link to other electronic data. This other electronic data may be of a type other than text or graphics, such as, for example, application programs or audio. An electronic message can include, for example, Uniform Resource Identifiers(“URIs”) and/or icons that, when selected (e.g. by using a mouse to “click” the URI or icon), cause the other electronic data to be accessed.

In this description and in the following claims, an “unwanted electronic message” is defined as an electronic message that a plurality of recipients have indicated is undesirable to receive. A recipient can indicate that it is undesirable to receive an electronic message by providing feedback to a collaborative filter module. An unwanted electronic message is defined to include unsolicited or junk electronics messages (frequently referred to as “SPAM”) or messages that include malicious programs such as a virus or Trojan horse.

Those skilled in the art will appreciate that the invention may be practiced in network computing environments with many types of computer system configurations, including routers, gateways, firewalls, proxies, personal computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired links, wireless links, or by a combination of hardwired or wireless links) through a communication network, both perform tasks. In a distributed system environment, program modules may be located in both local and remote memory storage devices.

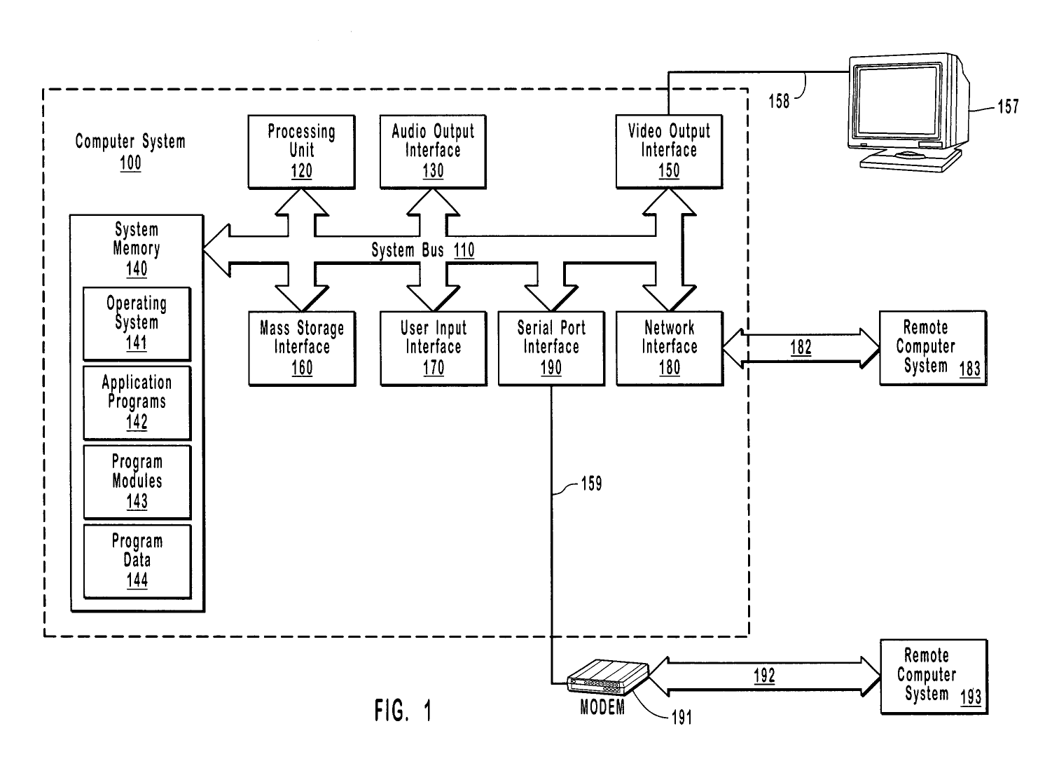

FIG. 1 and the following discussion are intended to provide a brief, general description of a suitable computing environment in which the invention may be implemented. Although not required, the invention will be described in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing steps of the methods disclosed herein. The particular sequences of such executable instructions or associated data structures represent examples of corresponding acts for implementing the functions described in such steps.

With reference to FIG. 1, a suitable operating environment for the principles of the invention includes a general-purpose computer system in the form of a computer system 100. Computer system 100 may be a personal computer that has been adapted to perform the operations disclosed herein. It should be understood that computer system 100 is merely an example of one possible computer system configuration that can be used to practice the principles of the present invention.

Computer system 100 includes a user input interface 170 that receives information from an input device, such as, for example, a keyboard, microphone, or mouse. An input device can be coupled to user input interface 170 so as to enable the entry of information. An input device can transfer information over such a coupling in response to preprogrammed data or user manipulation of the input device.

Computer system 100 also includes video output interface 150, which can provide a video output signal to external video display devices. Computer system 100 may be integrally positioned with or separate from a video display device, such as, for example, computer monitor 157. Computer monitor 157 can be coupled to video output interface 150 via video link 158 so as to receive a provided video output signal.

Similarly, computer system 100 includes an audio output interface 130 that provides an audio output signal to external audio output devices. Computer system 100 may also be integrally positioned with or separate from an audio system, which includes a speaker or other device capable of emitting sound data. An audio system can be coupled to audio output interface 130 so as to receive a provided audio output signal.

Computer system 100 includes processing unit 120, which allows for complex and flexible general-purpose processing capabilities. Processing unit 120 executes computer-executable instructions designed to implement features of computer system 100, including features of the present invention. Processing unit 120 is coupled to system bus 110, which also interconnects various other system components, including system memory 140.

System memory 140 generally represents a wide variety of volatile and/or non-volatile memories and may include types of memory previously discussed. However, the particular type of memory used in computer system 100 is not important to the present invention. Program code means comprising one or more program modules may be stored in system memory 140. The one or more program modules may include an operating system 141, one or more application programs 142, other program modules 143, and program data 144.

Computer system 100 may include mass storage interface 160, which can read data from and/or write data to a mass storage device, such as, for example, a magnetic disk storage device or optical disk storage device. A mass storage device can be coupled to mass storage interface 160 so as to enable the reading and writing of data. When a mass storage device is coupled to mass storage interface 160, one or more program modules including operating system 141, application programs 142, other program modules 143, and program data 144 may be stored in the mass storage device.

Computer system 100 can be network connectable to networks, such as, for example, an office-wide or enterprise-wide computer network, an intranet and/or the Internet. Computer system 100 can exchange data with external sources, such as, for example, remote computer systems and/or databases over such a network.

Computer system 100 includes network interface 180, through which computer system 100 receives data from external sources and/or transmits data to external sources. As illustrated in FIG. 1, network interface 180 facilitates the exchange of data with remote computer system 183 via logical communication link 182. Logical communication link 182 represents a portion of a network, and remote computer system 183 represents a node of the network. Remote computer system 183 can be an electronic messaging server that receives and stores electronic messages for recipients, including recipients that utilize computer system 100 to access electronic messages.

Likewise, computer system 100 includes serial port interface 190, through which computer system 100 receives data from external sources and/or transmits data to external sources. Serial port interface 190 is coupled to modem 191 via logical communication link 159, through which computer system 100 receives data from and/or transmits data to external sources. As illustrated in FIG. 1, serial port interface 190 and modem 191 facilitate the exchange of data with remote computer system 193 via logical communication link 192. Logical communication link 192 represents a portion of a network, and remote computer system 193 represents a node of the network. Remote computer system 193 can be an electronic messaging server that receives and stores electronic messages for recipients, including recipients that utilize computer system 100 to access electronic messages.

Alternatively, computer system 100 can exchange data with external sources through other interfaces, such as, for example, a parallel port, a game port, or a universal serial bus (“USB”) port.

It should be understood that the described network connections are merely examples. It would be apparent to one skilled in the art, after having reviewed this description, that a wide variety of network connection techniques, in addition to those described with reference to FIG. 1, may be used to facilitate the exchange of data between computer system 100 and external sources.

While FIG. 1 represents a suitable operating environment for the present invention, the principles of the present invention may be employed in any computer system that is capable of, with suitable modification if necessary, implementing the principles of the present invention. The environment illustrated in FIG. 1 is illustrative only and by no means represents even a small portion of the wide variety of environments in which the principles of the present invention may be implemented.

In accordance with the present invention, collaborative filter modules, individualized filter modules, and electronic messaging modules, as well as associated data, including electronic messages and message folders may be stored and accessed from any of the computer-readable media associated with computer system 100. For example, portions of such modules and portions of associated program data may be included in operating system 141, application programs 142, program modules 143 and/or program data 144, for storage in system memory 140. If a mass storage device is coupled to computer system 100, such modules and associated program data may also be stored in the mass storage device.

In a networked environment, program modules depicted relative to computer system 100, or portions thereof, can be stored in remote memory storage devices, such as, for example, system memory and/or mass storage devices associated with remote computer system 183 and/or remote computer system 193. Execution of such modules may be performed in a distributed environment as previously described.

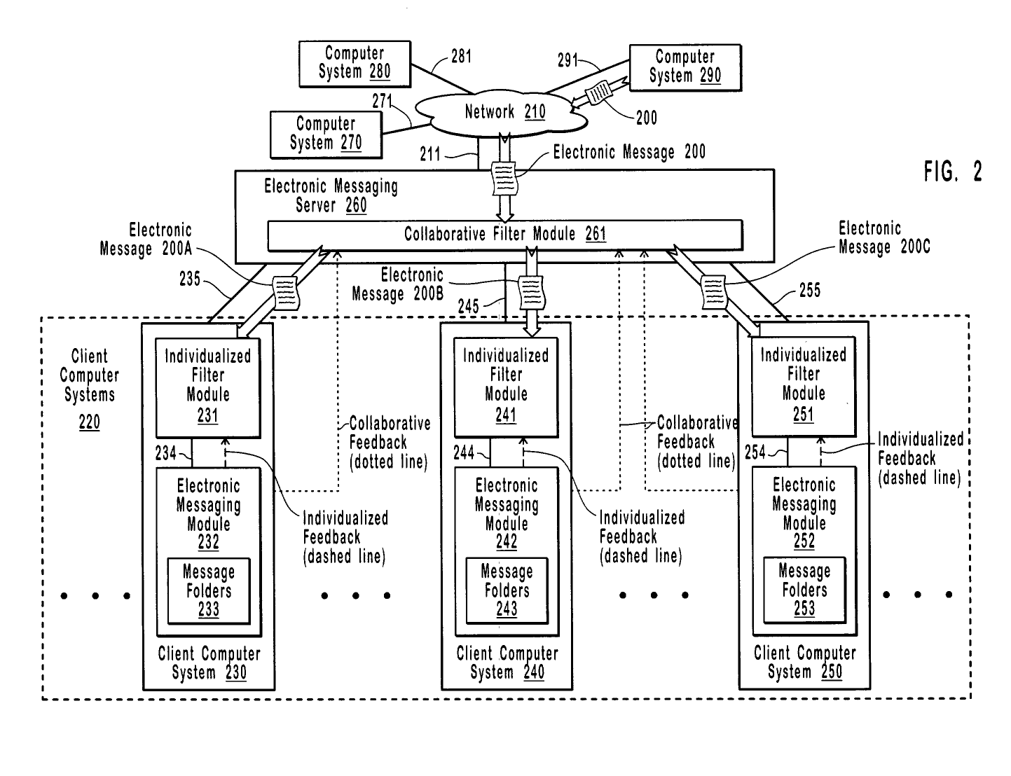

FIG. 2 illustrates some of the functional components that can facilitate categorizing an electronic message as unwanted based on collaborative feedback. Shown in FIG. 2 is electronic messaging server 260 that is connected to network 210 via logical communication link 211. Computer systems 270, 280, and 290 are also connected to network 210 via corresponding logical communication links 271, 281, and 291. Client computer systems 230, 240, and 250 are connected to electronic messaging server 260 via corresponding logical communication links 235, 245, and 255.

Any of the computer systems 270, 280, and 290 may at times send an electronic message to a recipient that accesses the electronic message using one of the client computer systems included in client computer systems 220. When an electronic message is sent to a recipient, electronic messaging server 260 can receive and store the message for the recipient. For example, computer system 290 may send electronic message 200 to a recipient that accesses electronic messages at client computer system 230. Message 200 may travel from computer system 290, via logical communication link 291, to network 210 and from network 210, via logical communication link 211, to electronic messaging server 260. Electronic message 200 would be received by electronic message server 260 and stored until the recipient utilizes client computer system 230 to access electronic message 200.

Recipients can access an electronic message from electronic messaging server 260 by activating an electronic messaging module (e.g. electronic messaging modules 232, 242, or 252). This may cause a copy of the electronic messages to be transferred to the client computer system via a corresponding logical communication link. An electronic messaging module can be, for example, a portion of an electronic mail application, a portion of an instant messaging application, or a portion of an a news group reader application. In the previous example, the recipient could active electronic messaging module 232 to access electronic messages 200A. The body of electronic message 200A would be essentially identical to electronic message 200. However, electronic messaging server 260 may alter the identifier included in the message, for example, when aliases are used.

An accessed electronic message can be stored when future access to the electronic message is desired. Client computer systems 230, 240, and 250 include corresponding message folders 233, 243, and 253, which can be used to store accessed electronic messages. In the previous example, client computer system 230 may utilize a folder included in message folders 233 to store electric message 200A.

Client computer systems 230, 240, and 250 can include corresponding individualized filter modules 231, 241, and 251 that attempt to identify unwanted electronic messages for an individual recipient. When a recipient accesses an electronic message from electronic messaging server 260, an individualized filter module can attempt to identify if the accessed electronic message is unwanted based on hard coded rules or on individual feedback from a recipient. The dashed lines shown in FIG. 2 illustrate that a recipient can provide individualized feedback to an individualized filter module. The dotted lines shown in FIG. 2 illustrate that a recipient can also provide collaborative feedback, which can be combined along with collaborative feedback from other recipients, to collaborative filter module 261.

It should be understood that other client computer systems, in addition to the illustrated client computer systems 230, 240 and 250, can be included in client computer systems 220. When three consecutive periods are encountered (i.e., an ellipsis), this represents that other client computer systems may precede the illustrated client computer systems or that other client computer systems may follow the illustrated computer systems.

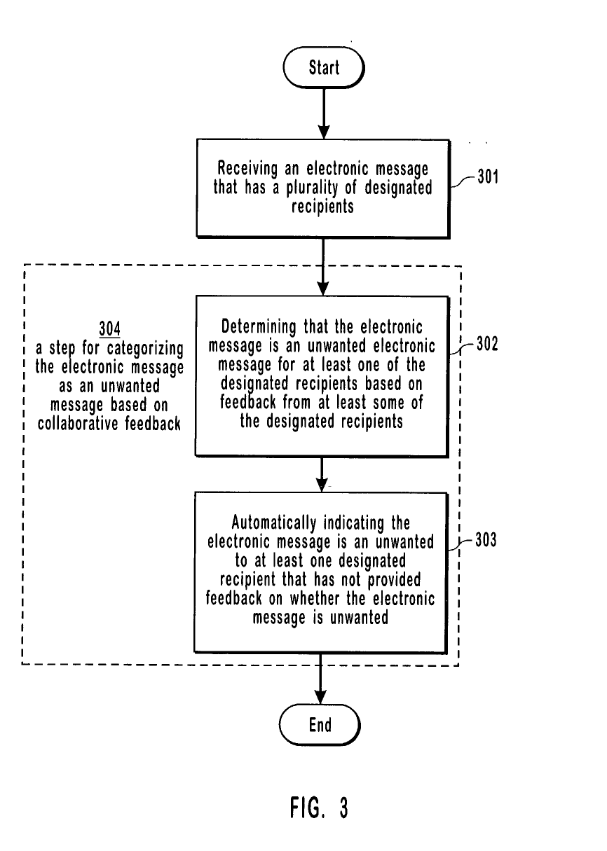

FIG. 3 is a flow diagram illustrating an example of a method for categorizing an electronic message as unwanted based on some recipients of the electronic message indicating that the electronic message is unwanted. The method in FIG. 3 will be discussed with reference to the functional components included in FIG. 2.

The method in FIG. 3 begins with an act of receiving an electronic message that has a plurality of designated recipients (act 301). Shown in FIG. 2, electronic messaging server 260 receives electronic message 200. Designated recipients at client computer systems 230, 240, and 250 (as well as recipients at other client computer systems) may activate corresponding electronic messaging modules including electronic messaging modules 232, 242, and 252. This can result in a plurality of copies of electronic message 200 (e.g. electronic messages 200A, 200B, and 200C) being accessed at a plurality of client computer systems. For example, electronic message 200A can be accessed at client computer system 230, electronic message 200B can be accessed at client computer system 240, and electronic message 200C can be accessed at client computer system 250.

The method in FIG. 3 includes a functional, result-oriented step for categorizing an electronic message as unwanted based on collaborative feedback (step 304). Step 304 may include any corresponding acts for accomplishing the result of categorizing an electronic message as unwanted based on collaborative feedback. However, in the illustrated example of FIG. 3, the step 304 includes a corresponding act of determining that the electronic message is an unwanted electronic message for at least one of the designated recipients based on feedback from at least some of the recipients (act 302).

Designated recipients may access copies of electronic message 200 (200A, 200B, 200C, etc) at different times. As designated recipients access copies of electronic message 200, some of the designated recipients may provide collaborative feedback indicating that electronic message 200 is an unwanted electronic message. A designated recipient may provide feedback, for example, by selecting a “Spam indicator” control in a user interface or by deleting the electronic message “as Spam” (as opposed to just deleting it).

Feedback from each designated recipient can be received at collaborative filter module 261. In some cases, designated recipients can provide collaborative feedback directly to collaborative filter module 261. In other cases, designated recipients can provide feedback to individualized filter modules or electronic message modules that in turn transfer the feedback to collaborative filter module 261. For example, when a designated recipient provides feedback at client computer system 230 indicating that electronic message 200A is an unwanted electronic message, electronic messaging module 232 or individualized filter 231 can send this feedback to collaborative filter module 261. In some cases, electronic messaging modules and/or individualized filter modules are an integral part of an operating system (i.e. operating system 141). In these cases, the operating system can send feedback, including collaborative feedback, to a collaborative filter module.

When the number of designated recipients indicating that electronic message 200 is an unwanted electronic message exceeds a specified threshold, collaborative filter module 261 may determine that electronic message 200 is an unwanted electronic message for other designated recipients that have not yet accessed electronic message 200. A specified threshold can be a number of designated recipients. For example, when 10 designated recipients provide feedback indicating that an electronic message is an unwanted electronic message, collaborative filter 261 may determine that the electronic message is an unwanted electronic message for other designated recipients. A specified threshold can also be a percentage of designated recipients. For example, when 5% of the designated recipients provide feedback indicating that an electronic message is an unwanted electronic message, collaborative filter 261 may determine that the electronic message is an unwanted electron message for other designated recipients.

In the illustrated example of FIG. 3, the step 304 also includes a corresponding act of automatically indicating the electronic message is unwanted to at least one designated recipient that has not provided feedback on whether the electronic message is unwanted (act 303). Message folders, such as, for example, message folders 233 can include a number of folders used to store electronic messages. When electronic message 200 is accessed, a copy of the electronic message 200, in this case electronic message 200A, can be stored in a folder include in message folders 233 for future viewing.

Message folders 233 may include an inbox folder and an unwanted messages folder. Based on collaborative feedback, collaborative filter module 261 may determine the folder included in message folders 233 where electronic message 200A is to be stored. In some cases, a designated recipient may access a copy of electronic message 200 before collaborative filter module 261 determines that electronic message 200 is an unwanted electronic message. If message 200 is accessed before collaborative filter module 261 makes this determination, electronic message 200A can be stored in an inbox folder. On the other hand, a designated recipient may access a copy of electronic message 200 after collaborative filter module 261 determines that electronic message 200 is an unwanted electronic message. If message 200 is accessed after electronic filter module 261 makes this determination, electronic message 200A can be stored in an unwanted messages folder.

In some embodiments, an electronic messaging module provides a first indication at a user interface when an electronic message is stored in an inbox folder and provides a second different indication at a user interface when an electronic message is stored in an unwanted messages folder. For example, when an electronic message is received in an inbox folder, the user interface can cause a sound to be emitted at an audio output device and a message, such as, for example, a “New Mail” message, to be displayed at a video display device. However, when a message is received in an unwanted messages folder the user interface may simply increment the display of the number of electronic messages currently contained in the unwanted messages folder.

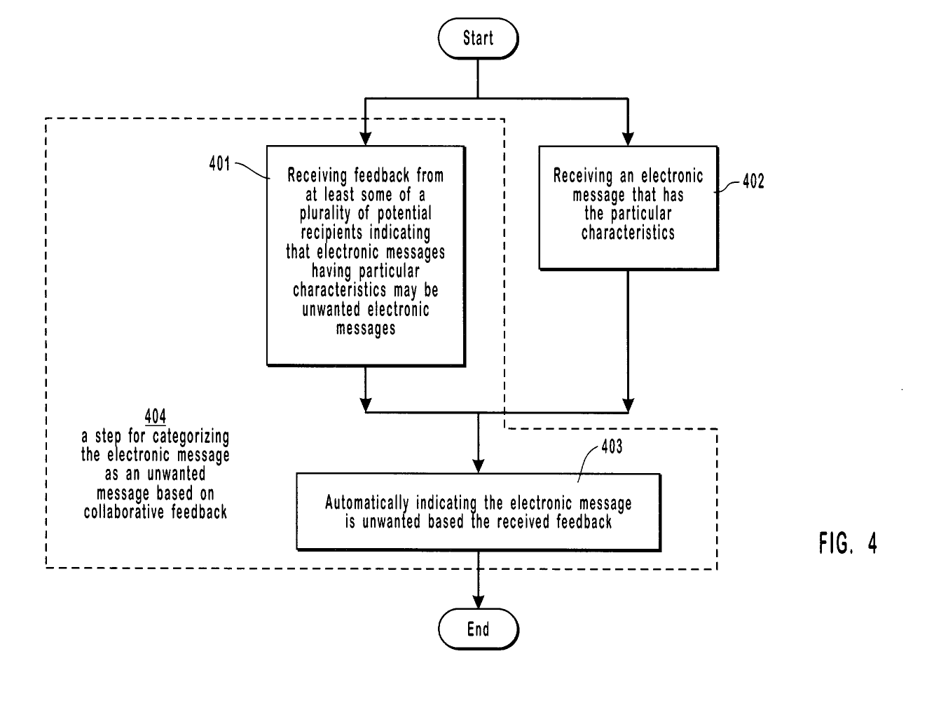

FIG. 4 is a flow diagram illustrating an example of a method for categorizing an electronic message as unwanted based on the characteristics of the electronic message. The method in FIG. 4 will be discussed with reference to the functional components included in FIG. 2.

The method in FIG. 4 includes a functional, result-oriented step for categorizing an electronic message as unwanted based on collaborative feedback (step 404). Step 404 may include any corresponding acts for accomplishing the result of categorizing an electronic message as unwanted based on collaborative feedback. However, in the illustrated example of FIG. 4, the step 404 includes a corresponding act of receiving feedback from at least some of a plurality of potential recipients indicating that messages having particular characteristics may be unwanted electronic messages (act 401).

As recipients access electronic messages at client computer systems contained in client computer systems 220, the recipients may provide feedback on the accessed electronic messages. Provided feedback for accessed electronic messages may be received by collaborative filter module 261. As previously described, recipients may provide feedback directly to collaborative filter 261 or electronic message modules, individualized filter modules, or operating systems may receive electronic messaging recipient feedback and then transfer the feedback to collaborative filter module 261.

Characteristics of an electronic message may include, for example, the addresses in a “To,” “Cc,” or “From” field of the electronic message, key words in the body of the electronic message, the time and date the electronic message was sent, and files that are attached to the electronic message. The collaborative filter may combine feedback from each recipient with the feedback from all the other recipients to formulate the particular characteristics that are more likely to be associated with unwanted electronic messages.

The method in FIG. 4 includes an act of receiving an electronic mail message that has the particular characteristics (act 402). When an electronic message is received at electronic messaging server 260, collaborative filter module 261 analyzes the characteristics of the message. Collaborative filter module 261 compares the characteristics of the received electronic message to the particular characteristics that are more likely to be associated with unwanted electronic messages. When there is a specified level of commonality between the characteristics of a received electronic message and the particular characteristics that are more likely to be associated with unwanted electronic messages, the received electronic message may be viewed as having the particular characteristics.

In the illustrated example of FIG. 4, the step 404 also includes a corresponding act of automatically indicating the electronic message is unwanted based on the received feedback (act 403). When a received electronic message has the particular characteristics, collaborative filter module 261 may determine that the received electronic message is an unwanted electronic message. Collaborative filter module 261 may cause the unwanted electronic message to be stored in an unwanted messages folder. Further, collaborative filter module 261 may cause a client computer system to indicate that a message has been stored in the unwanted messages folder.

By using collaborative feedback, some users may be relieved from having to actually view an electronic message to determine that the electronic message is an unwanted electronic message. Further, filters that categorize electronic messages based on the characteristics of electronic messages may be trained more efficiently since feedback is recieve from a plurality of users.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embrased within their scope.

What is claimed and desired secured by United States Letters Patent is:

1. In an electronic messaging computer system that serves a plurality of potential electronic message recipients, a method for categorizing electronic messages, the method comprising:
an act of receiving an electronic message that has a plurality of designated recipients from among the plurality of potential electronic message recipients;
an act of determining that the electronic message is an unwanted electronic message for at least one of the plurality of designated recipients based on feedback from one or more of the plurality of designated recipients; and
an act of automatically indicating the electronic message is an unwanted electronic message to at least one of the plurality of designated recipients that has not provided feedback on whether the electronic message is unwanted.

2. The method as recited in claim 1, wherein the act of receiving an electronic message that has a plurality of designated recipients comprises:
an act of receiving an electronic mail message that has a plurality of designated recipients.

3. The method as recited in claim 1, wherein the act of determining that the electronic message is an unwanted electronic message for at least one of the plurality of designated recipients based on feedback comprises:
an act of determining that the electronic message is an unwanted electronic C message when a specified number of designated users provides feedback indicating the electronic message is an unwanted electronic message.

4. The method as recited in claim 1, wherein the act of determining that the electronic message is an unwanted electronic message for at least one of the plurality of designated recipients based on feedback comprises:
an act of determining that the electronic message is an unwanted electronic message when a specified percentage of designated users provides feedback indicating the electronic message is an unwanted electronic message.

5. The method as recited in claim 1, wherein the act of determining that the electronic message is an unwanted electronic message for at least one of the plurality of designated recipients based on feedback comprises:
an act of a collaborative filter module determining that the electronic message is an unwanted electronic message based on feedback.

6. The method as recited in claim 5, wherein the act of a collaborative filter module determining that the electronic message is an unwanted electronic message based on feedback determining comprises:
an act of a collaborative filter module determining that the electronic message is an unwanted electronic message based on feedback received from a plurality of individualized filter modules.

7. The method as recited in claim 5, wherein the act of a collaborative filter module determining that the electronic message is an unwanted electronic message based on feedback determining comprises:
an act of a collaborative filter module determining that the electronic message is an unwanted electronic message based on feedback received from a plurality of electronic messaging modules.

8. The method as recited in claim 1, wherein that act of determining that the electronic message is an unwanted electronic message for at least one of the plurality of designated recipients based on feedback comprises:
an act of determining that the electronic message is SPAM.

9. The method as recited in claim 1, wherein the act of determining that the electronic message is an unwanted electronic message for at least one of the plurality of designated recipients based on feedback comprises:
an act of determining that the electronic message contains a malicious program.

10. The method as recited in claim 1, wherein the act of determining that the electronic message is an unwanted electronic message for at least one of the plurality of designated recipients based on feedback comprises:
an act of at least some of the designated recipients selecting an option from a user-interface to indicate the electronic message is an unwanted electronic message.

11. The method as recited in claim 1, wherein the act of automatically indicating the electronic message is an unwanted electronic message to at least one of the plurality of designated recipients comprises the following:
an act of automatically storing the electronic message in an unwanted messages folder.

12. In an electronic messaging computer system that serves a plurality of potential electronic message recipients, a method for categorizing electronic messages, the method comprising:
an act of receiving an electronic message that has a plurality of designated recipients from among the plurality of potential electronic message recipients; and
a step for categorizing the electronic message as an unwanted electronic message based on collaborative feedback.

13. In an electronic messaging computer system that serves a plurality of potential electronic message recipients, a method for categorizing electronic messages, the method comprising:
an act of receiving feedback from at least some of the plurality of potential recipients indicating that electronic messages having particular characteristics may be unwanted electronic messages;
an act of receiving an electronic message that has the particular characteristics; and
an act of automatically indicating the electronic message is unwanted based on the feedback received from the at least some of the plurality of potential recipients.

14. The method as recited in claim 13, wherein the act of receiving feedback from at least some of the plurality of potential recipients indicating that electronic messages having particular characteristics may be unwanted electronic messages comprises the following:
an act of receiving feedback from at least some of the plurality of potential recipients indicating that electronic mail messages having particular characteristics may be unwanted electronic messages.

15. The method as recited in claim 13, wherein the act of receiving feedback from at least some of the plurality of potential recipients indicating that electronic messages having particular characteristics may be unwanted electronic messages comprises the following:
an act of receiving feedback from at least some of the plurality of potential recipients indicating that electronic messages from particular senders may be unwanted electronic messages.

16. The method as recited in claim 13, wherein the act of receiving feedback from at least some of the plurality of potential recipients indicating that electronic messages having particular characteristics may be unwanted electronic messages comprises the following:
an act of receiving feedback from at least some of the plurality of potential recipients indicating that electronic messages that contain particular text may be unwanted electronic messages.

17. The method as recited in claim 13, wherein the act of receiving feedback from at least some of the plurality of potential recipients indicating that electronic messages having particular characteristics may be unwanted electronic messages comprises the following:
an act of receiving feedback from at least some of the plurality of potential recipients indicating that electronic messages that contains a particular graphic may be unwanted electronic messages.

18. The method as recited in claim 13, wherein the act of receiving feedback from at least some of the plurality of potential recipients indicating that electronic messages having particular characteristics may be unwanted electronic messages comprises the following:
an act of receiving feedback from at least some of the plurality of potential recipients indicating that electronic messages that contain particular malicious programs may be unwanted electronic messages.

19. The method as recited in claim 13, wherein the act of receiving an electronic message that has the particular characteristics comprises the following:
an act of receiving an electronic mail message that has the particular characteristics.

20. The method as recited in claim 13, wherein the act of receiving an electronic message that has the particular characteristics comprises the following:
an act of receiving an electronic message from a particular sender.

21. The method as recited in claim 13, wherein the act of receiving an electronic message that has the particular characteristics comprises the following:
an act of receiving an electronic message that contains particular text.

22. The method as recited in claim 13, wherein the act of receiving an electronic message that has the particular characteristics comprises the following:
an act of receiving an electronic message that contains a particular graphic.

23. The method as recited in claim 13, wherein the act of receiving an electronic message that has the particular characteristics comprises the following:
an act of receiving an electronic message that contains a particular malicious program.

24. The method as recited in claim 13, wherein the act of automatically indicating the electronic message is unwanted based on the feedback received from the at least some of the plurality of potential recipients comprises the following:
an act of automatically storing the electronic message in an unwanted messages folder.

25. In an electronic messaging computer system that serves a plurality of potential electronic message recipients, a method for categorizing electronic messages, the method comprising:
an act of receiving an electronic message that has particular characteristics; and
a step for categorizing the electronic message as an unwanted message based on collaborative feedback.

26. A computer program product for use in an electronic messaging computer system that serves a plurality of potential electronic message recipients, the computer program product for implementing a method for categorizing electronic messages, the computer program product comprising:
one or more computer-readable media carrying computer-executable instructions, that when executed at the electronic messaging computer system, cause the electronic messaging computer system to perform the method, including:
receiving an electronic message that has a plurality of designated recipients from among the plurality of potential electronic message recipients;
determining that the electronic message is an unwanted electronic message for at least one of the plurality of designated recipients based on feedback from one or more of the plurality of designated recipients; and
indicating the electronic message is an unwanted electronic message to at least one of the plurality of designated recipients that has not provided feedback on whether the electronic message is unwanted.

27. The computer program product as recited claim 26, wherein the one or more computer-readable media include physical storage media.

28. The computer program product as recited claim 26, wherein the one or more computer-readable media include system memory.

29. A computer program product for use in an electronic messaging computer system that serves a plurality of potential electronic message recipients, the computer program product for implementing a method for categorizing electronic messages, the computer program product comprising:
one or more computer-readable media carrying computer-executable instructions, that when executed at the electronic messaging computer system, cause the electronic messaging computer system to perform the method, including:
receiving feedback from at least some of the plurality of potential recipients indicating that electronic messages having particular characteristics may be unwanted electronic messages;
receiving an electronic message that has the particular characteristics; and
indicating the electronic message is unwanted based on the feedback received from the at least some of the plurality of potential recipients.

30. The computer program product as recited claim 29, wherein the one or more computer-readable media include physical storage media.

31. The computer program product as recited claim 29, wherein the one or more computer-readable media include system memory.

32. One or more computer-readable media having stored thereon an electronic messaging filter, the electronic messaging filter being configured to:
receive an electronic message;
categorize the electronic message as an unwanted electronic message based on feedback received from a plurality of electronic messaging recipients; and
indicate to at least one of the plurality of message recipients that the electronic message is unwanted.

33. The one or more computer-readable media having stored thereon an electronic messaging filter as recited in claim 32, wherein the electronic messaging filter is configured to categorize the electronic message as an unwanted electronic message based on feedback received from a plurality of electronic messaging recipients by being configured to categorize the electronic message as an unwanted electronic message based on express indications from the plurality of electronic messaging recipients.

34. The one or more computer-readable media having stored thereon an electronic messaging filter as recited in claim 32, wherein the electronic messaging filter is configured to categorize the electronic message as an unwanted electronic message based on feedback received from a plurality of electronic messaging recipients by being configured to categorize the electronic message as an unwanted electronic message based on the characteristics of the electronic message.

35. The one or more computer-readable media having stored thereon an electronic messaging filter as recited in claim 32, wherein the electronic messaging filter is configured to indicate to at least one of the plurality of message recipients that the electronic message is unwanted by being configured to store the electronic message in an unwanted messages folder.

36. In a client computer system that is used by one or more electronic messaging recipients to receive electronic messages, a method for an electronic message recipient to provide collaborative feedback associated with an electronic message, the method comprising:
an act of outputting an electronic message;
an act of receiving collaborative feedback from the electronic messaging recipient indicating that the electronic message may be an unwanted electronic message;
an act of transferring the collaborative feedback to a collaborative filter module that will combine the received collaborative feedback with collaborative feedback from the other electronic messaging recipients.

37. The method as recited in claim 36, wherein the act of transferring the collaborative feedback comprises the following:
an act of an operating system included in the client computer system causing the collaborative feedback to be transferred.

38. An electronic messaging server configured to collaboratively filter electronic messages, comprising:
one or more processing units; and
one or more computer-readable media having stored thereon an electronic messaging filter, the electronic messaging filter being configured to:
receive an electronic message;
categorize the electronic message as an unwanted electronic message based on feedback received from a plurality of electronic messaging recipients; and
indicate to at least one of the plurality of message recipients that the electronic message is unwanted.
